(19) United States
(12) Patent Application Publication
(10) Pub. No.: US 2014/0019239 A1
(43) Pub. Date: Jan. 16, 2014

(54) Social Quality Of Content

(71) Applicants: Yan Qu, Los Altos, CA (US); Nanda Kishore, Los Altos, CA (US); Timothy Schigel, Cincinnati, OH (US); Juan Valencia, Palo Alto, CA (US); Andrew Stevens, New York, NY (US); Ishika Paul, Mountain View, CA (US); Ping Zhu, Mountain View, CA (US)

(72) Inventors: Yan Qu, Los Altos, CA (US); Nanda Kishore, Los Altos, CA (US); Timothy Schigel, Cincinnati, OH (US); Juan Valencia, Palo Alto, CA (US); Andrew Stevens, New York, NY (US); Ishika Paul, Mountain View, CA (US); Ping Zhu, Mountain View, CA (US)

(21) Appl. No.: 13/547,812

(22) Filed: Jul. 12, 2012

(51) Int. Cl. G06Q 30/02; G06F 17/30

(52) U.S. Cl. 705/14.53; 705/14.6; 707/751; 707/740; 707/E17.046

(57) ABSTRACT

Embodiments for a method for ranking social quality of content published on a plurality of web pages are provided. In an embodiment, the method includes receiving at least one log record from a tracking component on at least one web page. The one log record is indicative of at least one user activity on the at least one web page. The method further includes aggregating the at least one log record corresponding to preferably each of the plurality of web pages based on one or more parameters. The method also includes assigning a first score for preferably each of the plurality of web pages based on the aggregating. The first score is indicative of a social quality of content published in the at least one web page. The method includes ranking the plurality of web pages based on the first score.

### FIELD

The present disclosure relates, in general, to a ranking system. More specifically, the present disclosure relates to ranking content based on the social quality of the content.

### BACKGROUND

Recent years have seen multifold growth in global internet usage due to the increase in the number of internet users. At any instant, there may be millions of users involved in a variety of activities on the internet. Such activities can include, but are not limited to, searching for content, visiting a web page, viewing a video blog, social networking, listening to an audio file, shopping online, gaming online, sharing content, following friends or celebrities, and downloading content. Such user activities may be indicative of a user's interest and/or online behavioral pattern.

Due to such widespread popularity of the internet, various firms such as, but not limited to, advertisements firms, online shopping firms, consumer electronic firms, and retail stores, might want to reach out to these users for economic reasons. To this end, such firms may publish content, such as, but not limited to, advertisements and surveys on one or more web pages to reach out to the target users with the desired content.

Usually, content space on a web page is priced at a premium. Therefore, it may be desirable for such firms to identify content space that are economical and provide good return on investments.

### SUMMARY

Embodiments for a method for ranking social quality of content published on a plurality of web pages are provided. In an embodiment, the method includes receiving at least one log record from a tracking component on at least one web page. The one log record is indicative of at least one user activity on the at least one web page. The method further includes aggregating the at least one log record corresponding to each of the plurality of web pages based on one or more parameters. The method also includes assigning a first score for each of the plurality of web pages based on the aggregating. The first score is indicative of a social quality of content published in the at least one web page. The method includes ranking the plurality of web pages based on the first score.

### BRIEF DESCRIPTION OF DRAWINGS

The following detailed description of the embodiments of the disclosed invention will be better understood when read with reference to the appended drawings. The invention is illustrated by way of example, and is not limited by the accompanying figures, in which like references indicate similar elements.

FIG. 1 illustrates a block diagram of a computing environment in accordance with an embodiment;

FIG. 2 illustrates a block diagram of a web analytic server in accordance with an embodiment;

FIG. 3 illustrates a graphical representation of domains based on the social traffic and total traffic in accordance with an embodiment;

FIG. 4 illustrates a flow chart illustrating a method for ranking a plurality of web pages in accordance with an embodiment;

FIG. 5 illustrates a flow chart illustrating a method for providing an advertising campaign in accordance with an embodiment; and

FIG. 6 illustrates an exemplary table depicting social quality of content in terms of social quality percentile.

### DETAILED DESCRIPTION

The disclosed embodiments can be best understood with reference to the detailed figures and description set forth herein. Various embodiments are discussed below with reference to the figures. However, those skilled in the art will readily appreciate that the detailed description given herein with respect to these figures is just for explanatory purposes as methods and systems of the invention extend beyond the described embodiments.

### DEFINITION OF TERMS

Domain: Domain may correspond to an internet space, which can contain any resources like web page, network storage devices and servers. A domain can be owned by an individual, a group of persons, a corporation, etc. A domain may include one or more sub-domains and one or more web pages.

Sub-domain: Sub-domain is a type of domain that forms a part of a larger domain. Sub-domains are commonly used by publishers to assign unique names to different content types, functional groups, etc in the Domain Name System (DNS). For example, “mail.google.com” is a sub-domain of “google.com”.

Publisher: A publisher is a group, organization, company or an individual responsible for maintaining a web page. The publisher may select content such as advertisements, audio, video and surveys to be published on their web page.

Sharer: A sharer corresponds to a user that performs an operation of sharing content (e.g., a URL, a shortened URL of a web page, or copy and paste text snippets) with a plurality of users. In an embodiment, a sharer may correspond to a cookie representing a user. A sharer may also be referred to as an information sharer.

Clicker: A clicker corresponds to a user or a node that performs an operation of clicking on a URL shared by a sharer on a web page. In an embodiment, a clicker may correspond to a cookie representing a user. In most cases, the clicker performs the operation of clicking on a shortened URL of the URL that is shared by the sharer. A clicker may also be referred to as an information responder.

User activity: User activity corresponds to various activities performed by a user browsing the Internet. For example, the user activity can include a sharing activity, a clicking activity, a searching activity, and a web page view activity. Sharing activity usually entails a sharing of web content by a user with other users of the Internet through social channels such as Facebook®, Twitter®, and LinkedIn®. Clicking activity involves a user activity in which a user clicks on web content that is shared. Searching activity corresponds to a user activity in which a user searches for web content on the Internet.

Tracking component: Tracking components may include, but are not limited to, a widget, a button, a link, or a hypertext installed on a domain web server. The tracking component facilitates tracking and recording of one or more user activities usually as one or more log records.

Log record: A log record is a record of user activities performed on the Internet. Further, the log record may include a cookie, a timestamp, an event type, a sharing channel, a content type identifier, domain information, or a browser agent. The log record can also include an IP address that gives the geographical information, a reference URL that includes information about the source web page from where the user landed onto the current web page, a language identifier, a regional log, or a URL hash.

Total traffic: Total traffic denotes instances of any user activity on one or more of a publisher's web sites, a domain, a sub-domain or a web page. The total traffic can be calculated in real time.

Social traffic: Social traffic denotes instances of any user activity that involves sharing of content on at least one of a publisher's web sites, a domain, a sub-domain, or a web page. The social traffic can be calculated in real time. It would be appreciated by those skilled in the art that social traffic is a subset of total traffic.

Tracking pixel: Tracking pixel corresponds to a point or a pixel on a web page that captures one or more activities that a user performs on the web page.

Advertising campaign description: Advertisement campaign description may correspond to information/data related to an advertisement campaign. The advertisement campaign description may include keywords associated with the advertisement campaign, a tracking pixel on a web page hosted by an advertisement server, or at least one content category associated with the advertisement campaign.

Social quality: Social quality may correspond to a qualitative score given to a publisher, a domain, a sub-domain, or a web page based on the quality of social content published in a domain, sub-domain, or a web page. The content is subjected to one or more user activities, such as sharing.

Social Quality Index (SQI): In an embodiment, SQI is a quantitative measure of social quality of a content entity with respect to (or bench marketing against) a network of the content entities. The content entity can be a publisher, a domain, a sub-domain, or a web page. The SQI measure illustrates how a content entity compares with other similar types of content entities in terms of social quality and thus can be used as a competitive analytic for measuring the effectiveness of a web site in optimizing the social engagement of its users. A SQI lookup tool can be implemented for the public to view the SQI score of a content entity (e.g., a domain, a web page). Based on the SQI score, the publisher, the domain, the sub-domain, and the web page can be ranked.

One or more parameters: Parameters can include one or more of total number of visits to each web page, total number of sharing activities for each web page, total number of clicks for each web page, unique number of sharers for each web page, unique number of clickers for each web page, unique number of visitors for each web page, additional web page visits generated as a result of social clicks for each web page, category-relevant visits for each web page, category-relevant sharing activity for each web page, and category relevant click activity for each web page.

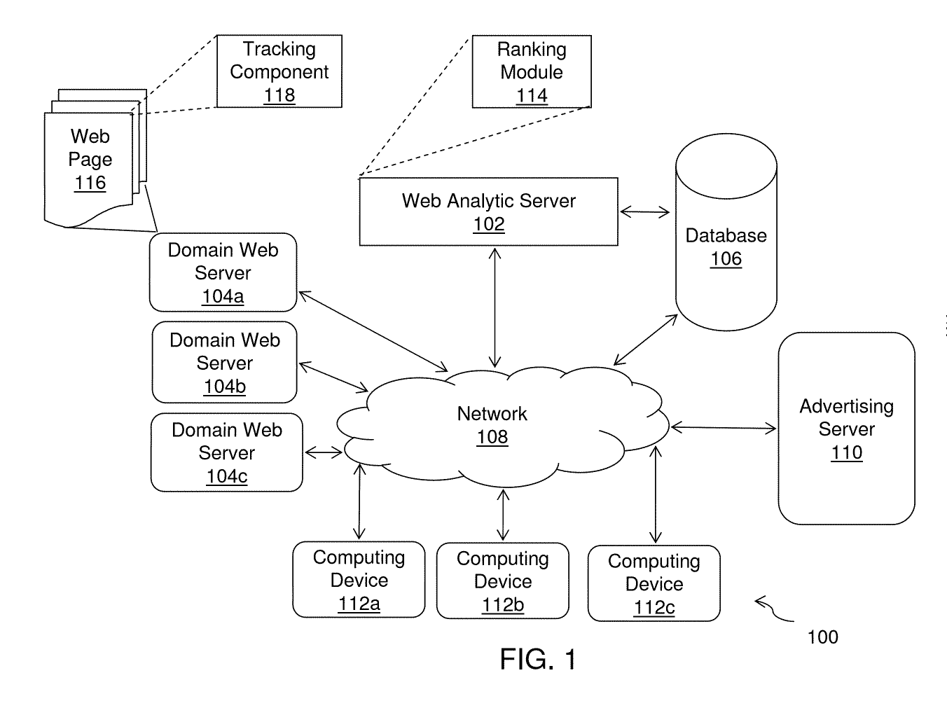

FIG. 1 illustrates a block diagram of a computing environment 100 in accordance with an embodiment. The computing environment 100 includes a web analytic server 102, one or more domain web servers 104a, 104b and 104c (generally referred to as 104), a database 106, a network 108, an advertising server 110 and one or more computing devices 112a, 112b and 112c (generally referred to as 112). The web analytic server 102 includes a ranking module 114. Preferably, each of the one or more domain web servers 104 hosts a plurality of web pages 116. Preferably, each of the web pages 116 comprises at least one tracking component 118.

In an embodiment, a web analytic server 102 corresponds to a web analytic system having capabilities to extract and analyze data for commercial purposes. The web analytic server 102 may extract the data using various querying languages, such as Structured Query Language (SQL), 4D Query Language, Object Query Language, and Stack Based Query Language (SBQL). Further, the web analytic server 102 includes various analytical tools such as, but not limited to, a tracking tool, a social behavior analytic tool, a social look-alike analytic tool, a probability calculation tool, an audience segmentation tool, a user modeling tool, campaign analytics, audience analytics, and a campaign optimization tool. In an embodiment, the web analytic server 102 maintains a domain tree in which a publisher includes one or more domains, where a domain may include one or more sub-domains which may further include one or more web pages 116.

The domain web server 104 usually corresponds to a web server owned by a publisher that includes data and information required to host one or more web sites. In an embodiment, the domain web server 104 installs a tracking component 118 that is configured to track and store data related to one or more user activities on the one or more web sites. Such data is stored as one or more log records. In an embodiment, the domain web server 104 maintains a domain tree, where a domain includes one or more sub-domains which may further include one or more web pages 116. Examples of the domain web server 104 may include, but are not limited to, Apache® web server, Microsoft® IIS server, Sun® Java System Web Server, etc.

In an embodiment, the database 106 corresponds to a storage device that stores data desired for providing web analytics services by the web analytic server 102. For example, the database 106 can be configured to store data related to at least one log record, at least one advertising campaign descriptor, data related to one or more domain web servers 104 and data related to advertising server 110. The database 106 can be implemented by using several technologies that are well known to those skilled in the art. Some examples of technologies may include, but are not limited to, MySQL®, Microsoft SQL®, etc. In an embodiment, the database 106 may be implemented as cloud storage. Examples of cloud storage may include, but are not limited to, Amazon E3®, Hadoop® distributed file system, etc.

The network 108 corresponds to a medium through which data and information flow among the various component of the computing environment 100. Examples of the network 108 may include, but are not limited to, a television broadcasting system, an IPTV network, a Wireless Fidelity (Wi-Fi) network, a Wireless Area Network (WAN), a Local Area Network (LAN) or a Metropolitan Area Network (MAN). The network 108 can connect with the various devices in the computing environment 100 through a variety of wired and wireless technologies such as Transmission Control Protocol (TCP/IP), User Datagram Protocol (UDP), 2G, 3G or 4 G communication technologies.

The advertising server 110 may correspond to a web server hosting one or more advertisements on a plurality of domains. For example, the advertising server 110 may host an online shopping web site or domain www.a1b2c3.com that offers products of one or more categories and/or brands. The advertising server 110 may include a database (e.g. 106) where an advertiser may store advertisements and associated data. The advertising server 110 can be configured to store and publish advertisements across the one or more domain web servers 104. Further, the advertising server 110 may publish an advertisement based on the analysis performed by the web analytic server 102. Example of advertising server 110, may include, but are not limited to, FTP server, HTTP server, mail server, proxy server, and Ad exchanges such as Google Double-Click Ad Exchange, etc.

The one or more computing devices 112 may correspond to a device capable of receiving an input from a user on a display. Examples of the computing device 112 may include, but are not limited to, a laptop, a television (TV), a desktop, a mobile phone, a gaming console, a tablet and other such devices having a display. The one or more computing devices 112 may include a processor, a memory, a display screen, one or more input means such as keyboard, mouse, and touch panels. Although three computing devices 112 have been shown in the figure, it may be appreciated that the disclosed embodiments can be implemented by a large number and different types of computing devices 112 from a particular manufacturer or across manufacturers. It may also be appreciated that, for a larger number of computing devices 112, the web analytic server 102 may be implemented as a cluster of computing devices configured to jointly perform the functions of the web analytic server 102.

In operation, the web analytic server 102 receives a request from the one or more domain web servers 104 to create an account in the web analytic server 102 for utilizing the services being offered by the web analytic server 102. The web analytic server 102 may accept the request and allow the one or more domain web servers 104 to use the services. The web analytic server 102 allows the domain web server 104 to download and install a software application to track one or more user activities on the domain web server 104. In an embodiment, the software application is a tracking application, which installs the tracking component 118 in the one or more web pages 116 being hosted by the one or more domain web servers 104.

A user browses through the one or more web pages 116 using at least one of the one or more computing devices 112 (e.g. 112a, 112b and 112c). The user performs one or more user activities on the content on the one or more web pages 116. The tracking component 118 on each of the one or more web pages 116 tracks the one or more user activities by collecting one or more log records. Further, the tracking component 118 sends the one or more log records to the web analytic server 102. In an embodiment, the web analytic server 102 analyzes the one or more log records to rank the social quality of content published on one or more web pages 116. In another embodiment, the web analytic server 102 ranks social quality of content on each of the one or more sub-domains based on the one or more log records. In yet another embodiment, the web analytic server 102 ranks the social quality of content in a plurality of domains hosting the one or more sub-domains or web pages 116 based on the one or more log records. In yet another embodiment, the web analytic server 102 ranks the social quality of publishers who own the one or more domains hosting the web pages 116 based on the one or more log records. In yet another embodiment, the web analytic server 102 ranks the one or more users visiting the web pages based on the one or more log records. In general, the web analytic server 102 ranks social quality of an entity associated with the plurality of web pages. The entity can be a domain, a sub-domain, or other web pages related with the plurality of web pages.

The advertising server 110 publishes at least one advertisement on the one or more web pages 116 hosted by the domain web server 104 based on the ranking of social quality of content. In an embodiment, the advertising server 110 publishes the advertisement to target a set of users based on the one or more log records.

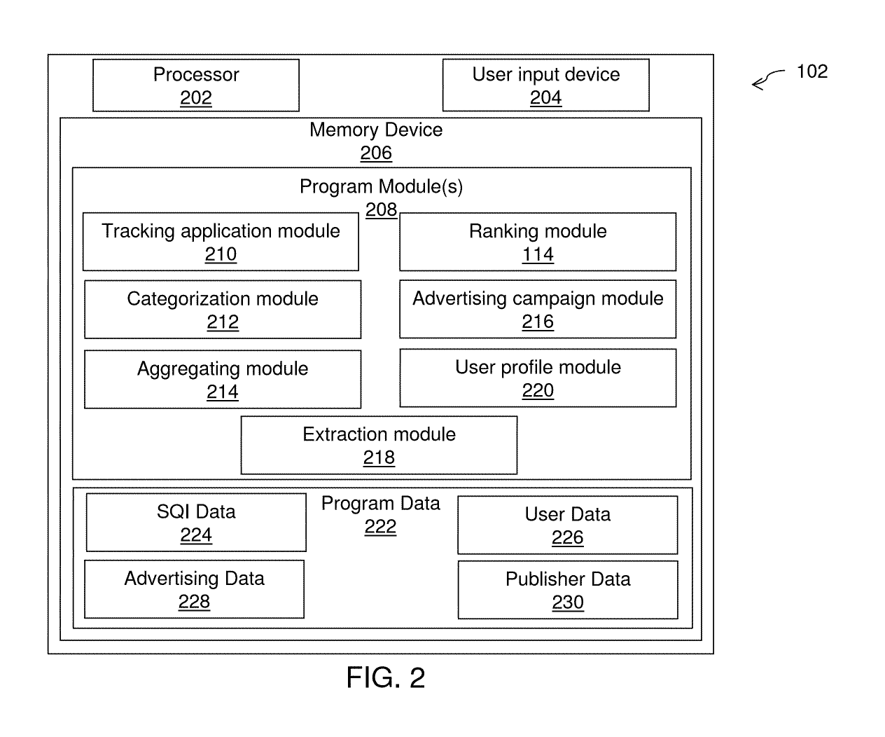

FIG. 2 illustrates a block diagram of a web analytic server 102 in accordance with an embodiment. The web analytic server 102 includes a processor 202, a user input device 204 and a memory device 206. FIG. 2 is described in conjunction with FIG. 1.

The processor 202 is coupled to the user input device 204 and the memory device 206. The processor 202 is configured to execute a set of instructions stored in the memory device 206. The processor 202 can be realized through a number of processor technologies known in the art. Examples of the processor 202 can be, but are not limited to, X86 processor, RISC processor, ASIC processor, CSIC processor, or any other processor. The processor 202 fetches the set of instructions from the memory device 206 and executes the set of instructions.

The user input device 204 receives a user input. Examples of the user input device 204 may be, but are not limited to, a keyboard, a mouse, a joystick, a gamepad, a stylus or a touch screen.

The memory device 206 is configured to store data and a set of instructions or modules. Some of the commonly known memory device implementations can be, but are not limited to, a random access memory (RAM), read only memory (ROM), hard disk drive (HDD), and secure digital (SD) card. The memory device 206 includes a program module partition 208 that further includes a tracking application module 210, a categorization module 212, an aggregating module 214, a ranking module 114 (refer FIG. 1), an advertising campaign module 216, an extraction module 218, and a user profile module 220. Although various modules in the program module partition 208 have been shown in separate blocks, it may be appreciated that one or more of the modules may be implemented as an integrated module performing the combined functions of the constituent modules.

The memory device includes a program data partition 222 that further includes SQI data 224, user data 226, advertising data 228, and publisher data 230.

The tracking application module 210 is configured to receive one or more log records from the tracking component 118 on the one or more web pages 116. The tracking application module 210 stores the one or more log records as the user data 226. In an embodiment, the tracking application module 210 is configured to provide the tracking application to each of the one or more domain web servers 104. In an embodiment, the tracking application module 210 maintains subscriptions for each publisher maintaining the one or more domain web servers 104. Further, the tracking application module 210 stores publisher's subscription data as the publisher data 230.

The categorization module 212 extracts the one or more log records from the user data 226. In an embodiment, the categorization module 212 classifies the one or more log records in different categories based on the content of the web page 116. Examples of categories include sports, mobiles, clothing, jewelry, automobiles, and/or the like.

The aggregating module 214 is configured to aggregate the one or more log records associated with content at different levels for one or more entities (e.g. publishers, domains, sub-domains, or web pages) based on one or more parameters. The one or more parameters can include one or more of total number of visits to each web page, unique number of sharers for each web page, unique number of clickers for each web page, unique number of visitors for each web page, additional web page visits generated as a result of social clicks for each web page, category-relevant visits for each web page, category-relevant sharing activity for each web page, and category relevant click activity for each web page. In an embodiment, the aggregating module 214 assigns a score to each of the one or more entities based on social quality and predefined weighting functions. For example, the aggregating module 214 assigns a first score to each of the plurality of web pages based on the aggregation of log records. The first score may indicate a social quality of each of the web pages. In another example, the aggregating module 214 assigns a second score to a plurality of sub-domains associated with the plurality of web pages based on the aggregation of log records. In another example, the aggregating module 214 assigns a third score to a plurality of domains associated with the plurality of web pages based on the aggregation of log records.

The ranking module 114 is configured to assign a rank to preferably each of the plurality of domains based on the score provided by the aggregating module 214. In an embodiment, the ranking module 114 can be configured to rank the one or more entities based on the respective scores. In an embodiment, the ranking module 114 ranks any of the one or more entities based on a combination of the first score, the second score and the third score.

The advertising campaign module 216 is configured to receive advertising campaign descriptions from the advertising server 110.

The extraction module 218 is configured for extracting at least one of a list of domains, a list of sub-domains, or a list of web pages (in general, any entity) based on at least one identified top ranking category and the rank assigned to each of the entities. Each of these lists corresponds to a relative preference for providing an advertising campaign on one or more domains, one or more sub-domains, and one or more web pages. Further, the extraction module 218 may extract the lists based on user preference.

The user profile module 220 is configured to create a user profile based on the one or more log records. Further, the user profile module 220 stores the user profile in the user data 226.

In operation, the categorization module 212 extracts one or more log records from the user data 226. Thereafter, the categorization module 212 analyzes and categorizes preferably each of the one or more log records in one or more predefined categories based on the content of the web page 116. For example, a user has performed one or more user activities on web content related to ‘medicine’. The log records corresponding to such web content may be categorized under category, such as, ‘healthcare’. In an embodiment, the one or more log records may be categorized under a sub category. For example, the ‘healthcare’ may include a sub category named ‘medicines’.

Since the one or more log records are indicative of one or more user activities performed on a plurality of web pages, the categorization module 212 may categorize preferably each of the plurality of web pages in one or more predefined categories. In an embodiment, the categorization module 212 categorizes the one or more sub-domains (associated with the web pages) in the one or more predefined categories. In another embodiment, the categorization module 212 categorizes one or more domains in the one or more predefined categories based on the one or more log records.

The aggregating module 214 aggregates and annotates the one or more log records associated with preferably each of the entities. Thereafter, based on the aggregation of the one or more log records, the aggregating module 214 calculates a score for preferably each of the entities. For example, the aggregating module 214 calculates the third score for each of the plurality of domains based on the ratio of social traffic to total traffic associated with the plurality of domains. In an embodiment, the third score is indicative of social quality of each of the plurality of domains.

In an alternative embodiment, the aggregating module 214 assigns a score to preferably each of the one or more content categories that are associated with each of the one or more domains based on the ratio of social traffic to total traffic associated with each of the one or more categories. For example, “macys.com” may include various categories such as ‘lifestyle’, ‘computers’, and ‘clothing’. The aggregating module 214 may assign a score to each of the categories. Based on the score assigned to the one or more categories, the aggregation module 214 assigns a score to an entity (e.g. domain, sub-domain, web page) associated with the one or more categories.

The ranking module 114 ranks/indexes the entities (e.g. publishers, domains, sub-domains and web pages) based on the score assigned by the aggregating module 214. In an alternative embodiment, the ranking module 114 ranks/indexes preferably each of the one or more categories and each of the one or more sub-categories. Further, the ranking module stores the ranks/indexes as the SQI data 224.

In an embodiment, the advertising campaign module 216 receives an advertising campaign description from the advertising server 110. The categorization module 212 determines one or more categories associated with the advertising campaign description. Based on the one or more categories associated with the advertising campaign description and the ranks assigned to each of the entities, the extraction module 218 extracts a list of entities corresponding to the one or more categories associated with the advertising campaign descriptor from the SQI data 224. In an embodiment, the advertiser may utilize the extracted list of entities to publish their advertisements.

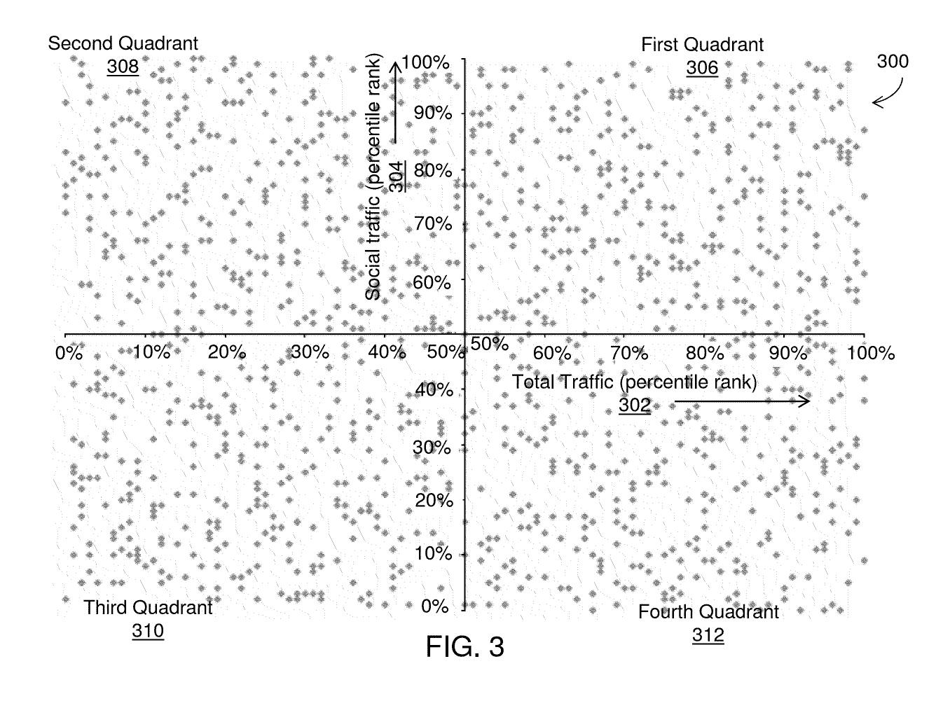

For example, the advertising campaign module 216 receives an advertisement campaign descriptor for a media and entertainment brand. The categorization module 212 identifies one or more categories associated with the advertisement campaign descriptor for the brand. For instance, the one or more categories include, ‘entertainment’, ‘travel’, and ‘cartoons’. The extraction module 218 extracts a list of domains under the ‘travel’, ‘entertainment’, and ‘cartoons’ categories from the SQI data 224. The extracted domains can be ranked based on their respective social quality scores stored in the SQI data 224. The brand may target one or more top ranked domains in the list of domains to publish their advertisements. In an embodiment, domains in the list of domains may be graphically represented based on the social traffic and the total traffic as shown in FIG. 3. The social traffic is generated based on sharing activities performed by the one or more users on at least one of publisher's web sites, domains, sub-domains, or web pages. The total traffic is generated based on any user activity on at least one of the publisher's web sites, domains, sub-domains or web pages.

FIG. 3 illustrates a graphical representation 300 of the list of domains based on the social traffic in percentile rank and total traffic in percentile rank in accordance with an embodiment of the disclosure. It may be noted that the list of domains have been considered for explaining the graphical representation for illustration purposes only. Similar graphical representations are possible for other entity types.

The graphical representation 300 includes an X-axis depicting in percentile rank total traffic 302 associated with each of the one or more domains in the network 108. Further, the graphical representation includes a Y-axis depicting in percentile rank social traffic 304 associated with each of the one or more domains in the network 108. In an embodiment, the total traffic 302 and the social traffic 304 represent percentile rank of the one or more domains in the network 108. Each diamond plotted in four quadrants of the graphical representation 300 represents a domain.

First quadrant 306 of the four quadrants of the graphical representation 300 shows big domains that experience large total traffic and social traffic. Second quadrant 308 of the four quadrants of the graphical representation 300 represents the domains that do not experience large total traffic but have an appreciable social traffic. Third quadrant 310 of the four quadrants of the graphical representation 300 represents domains that neither experience large total traffic nor large social traffic. Fourth quadrant 312 of the four quadrants of the graphical representation 300 represents domains that have large total traffic but do not experience large social traffic. A person skilled in the art would appreciate that the scope of the invention should not be limited to the graphical representation 300. Various other data representation schemes can be used for representing the domains with respect to social traffic and total traffic. It may be appreciated that the social quality of the domains can be represented in a variety of ways without departing from the scope of the ongoing description.

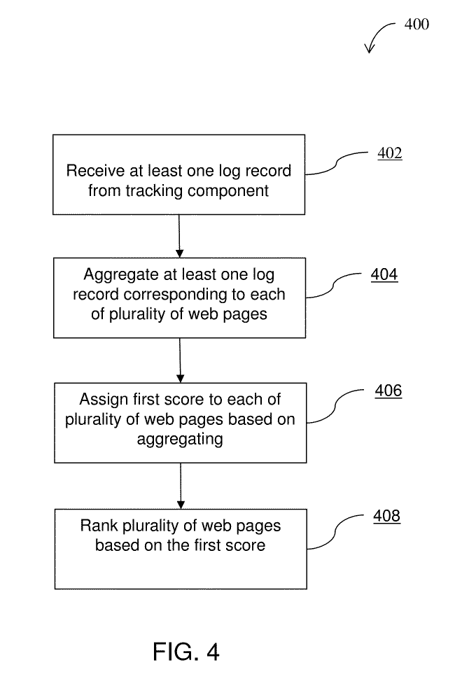

FIG. 4 is a flowchart 400 illustrating a method for ranking social quality of content published on a plurality of web pages in accordance with an embodiment. The flowchart 400 is explained in conjunction with FIG. 1 and FIG. 2.

At step 402, the tracking application module 210 (Refer FIG. 2) receives the one or more log records from the tracking component 118 (Refer FIG. 1) of one or more web pages 116. The tracking application module 210 stores the one or more log records as the user data 226. The categorization module 212 extracts the one or more log records from the one data 226. In an embodiment, the categorization module 212 categorizes the one or more log records based on the content of the web page 116. In an embodiment, the categorization process is hierarchal. The broad level categories can be further divided into sub categories. In one embodiment, for the category “sports”, the sub categories can be “soccer”, “cricket” and “badminton”. In another embodiment, a log record can be categorized into multiple categories.

At step 404, the aggregating module 214 aggregates the one or more log records associated with each of the plurality of web pages based on one or more parameters.

At step 406, a first score is assigned to each of the plurality of web pages based on the aggregating. The first score is stored in the SQI data 224. In an embodiment, the first score is assigned based on the total traffic and the social traffic associated with each of the plurality of web pages. In an embodiment, the score is the ratio of the social traffic on the domain to the total traffic on the domain. In yet another embodiment, the score is a weighted combination of the social traffic and the ratio of the social traffic to the total traffic. In yet another embodiment, the aggregates of the social traffic, the total traffic, the ratios, and the combination scores can be further transformed into scores (e.g., ranks, percentiles, quartiles, percentile ranks, and/or the like) measuring the relative standing of the scores with respective to other scores in the network 108. The score in the embodiment may be formulated as:

Score=(W₁*percentile_rank (social traffic)+W₂*percentile_rank (social traffic/total traffic))

where W₁ and W₂ are predefined weights.

In an embodiment, the first score is defined as social quality associated with each of the plurality of web pages. Similarly, a second score can be assigned to each of the plurality of sub-domains based on the aggregation. Similarly, a third score can be assigned to each of the plurality of domains based on the aggregation. The second score and the third score are also stored in the SQI data 224.

At step 408, the plurality of web pages are ranked based on the first score. Similarly, the one or more sub-domains and the one or more domains are ranked based on the second score and the third score respectively. In an embodiment, the first score, the second score and the third score are aggregated to generate a combined score. In an embodiment, the ranking of the plurality of domains, sub-domains and web pages can be category specific or user specific or based on specific user activity.

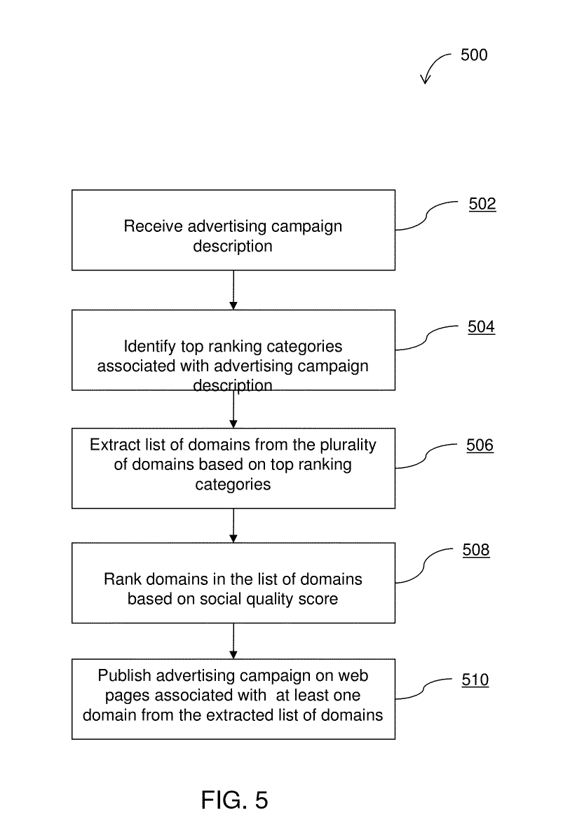

FIG. 5 illustrates a flowchart 500 illustrating a method for providing an advertising campaign in accordance with an embodiment. The flowchart 500 is explained in conjunction with FIG. 1 and FIG. 2.

At step 502, the advertising campaign module 216 (Refer FIG. 2) receives the advertising campaign description from the advertising server 110 (Refer FIG. 1). In an embodiment, the advertising campaign description includes, but is not limited to, keywords, a social pixel or at least one content category.

At step 504, the categorization module 212 identifies the at least one top ranking category from one or more predefined categories based on the advertising campaign description. In an embodiment, the advertising campaign module 216 performs a keyword based identification of users for user based targeting. The aggregating module 214 extracts cookies containing keywords associated with the advertising campaign description. The aggregating module 214 identifies the users associated with the extracted cookies. In an embodiment, one or more algorithms for audience analytics can be performed on such data to identify top ranking categories associated with the users. Such top ranking category can be considered while extracting a list of preferred domains for publishing the advertisements. In yet another embodiment, the aggregating module 214 identifies a set of cookies from social pixels on the plurality of domains. The set of cookies correspond to top ranking categories that can be considered while extracting a list of preferred domains for publishing the advertisements. In an embodiment, the content category may be pre-defined or pre-specified when the advertisement campaign description is received.

At step 506, the extraction module 218 extracts a list of domains from the plurality of domains based on the at least one top ranking category.

At step 508, the ranking module 114 ranks domains in the list of domains associated with the top ranked category based on the social quality of each of the plurality of domains. In an embodiment, each of the plurality of domains is ranked based on a score provided by the aggregating module 214. In an embodiment, the score is the ratio of the social traffic on the domain to the total traffic on the domain. In yet another embodiment, the score is the weighted combination of the social traffic and the ratio of the social traffic to the total traffic.

At step 510, the advertising server 110 publishes the one or more advertisements on the plurality of domains from the list of domains based on the rank. In an embodiment, the advertising server 110 may select the plurality of domains from the list of domains based on Real Time Bidding (RTB). The ranks are fed into a RTB engine that defines bidding price for each of the plurality of domains based on the rank associated with each of the plurality of domains.

In an embodiment, one or more log records from the top ranked domains may be extracted to form an audience segment. In an embodiment, the audience segment may include a list of one or more target users that have a high probability of responding and converting advertisements into sales closure. The advertising server 110 publishes the advertisements on the top ranked domains for the one or more users in the audience segments.

In an embodiment, the step 510 further includes extracting information regarding at least one cookie from the extracted list of domains for providing the advertising campaign in a targeted manner. The at least one cookie represents a user visiting at least one web page associated with the at least one domain from the extracted list of domains. In such an embodiment, web pages outside of a particular domain may be considered for determining the suitability of the domain for publishing the advertisement. In an embodiment, based on extracted information, the advertising campaign can be published on one or more web pages associated with the at least one cookie.

Embodiments of a method for ranking a social quality of an entity associated with each of a plurality of web pages are disclosed. In an embodiment, the method includes receiving log records from a tracking component on each of the plurality of web pages. The method includes aggregating the log records corresponding to the entity. The method further includes assigning a score to the entity for each of the plurality of web pages based on the aggregating. The score is indicative of a social quality of content associated with the entity. The method includes ranking the entities based on the respective scores.

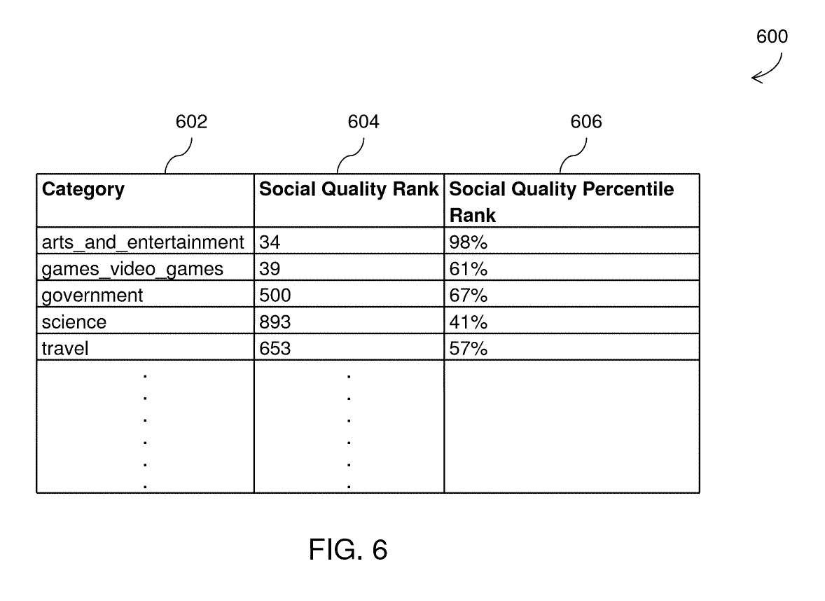

FIG. 6 illustrates an exemplary table 600 depicting social quality of content of an exemplary publisher for a plurality of categories in terms of social quality percentile. The web analytic server 102 determines a score by taking a combined measure of the publisher's outgoing share traffic and incoming clickback traffic, comparing it to total page views, and bench-marking the score against the scores of the other publishers in the network 108. Thereafter, the web analytic server 102 ranks social quality of content published on a plurality of web pages based on the scores determined. A column 602 labeled as “Category” corresponds to content category of a web page of a publisher (such as www.perezhilton.com). In the example, the exemplary publisher has been scored along 5 different categories based on the content of the web pages. For each category, the social quality rank 604 illustrates the rank of the publisher when compared with the other publishers in the same category based on the social quality score for that category. The social quality percentile 606 is another way of displaying a relative standing of the publisher compared with other publishers for the category. For example, the publisher has a social quality rank of 34 for the “arts_and_entertainment” content category, which means the publisher is ranked 34 in terms of social quality for the “arts_and_entertainment” category when compared with the other publishers with web pages of the same category. The social quality percentile 98% means that, for the “arts_and_entertainment” category, the publisher has a social quality score better than 98% of the publishers of that content category. Thus, the social quality score can be used as a competitive analytic for the publisher to understand what type of content is socially engaged on its web pages and how the social engagement is ranked against others. In another embodiment, the social quality score can be used by advertisers in selecting content of high social quality in order to reach socially engaged users.

In an embodiment, the entity corresponds to at least one of a domain or a sub-domain associated with the each of the plurality of web pages. In such an embodiment, the method includes assigning a first score to each of the plurality of web pages, assigning a second score to a sub-domain associated with each of the plurality of web pages, and assigning a third score to a domain associated with each of the plurality of web pages.

In such an embodiment, the ranking includes aggregating two or more of the first score, the second score, or the third score to generate a combined score and ranking the corresponding entity based at least in part on the combined score.

The disclosed methods and systems, as described in the ongoing description or any of its components, may be embodied in the form of a computer system. Typical examples of a computer system includes, but are not limited to, a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, and a display unit. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, etc. The storage device may also be other similar means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or any other similar device, which enables the computer system to connect to databases and networks, such as LAN, MAN, WAN and the Internet. The computer system facilitates inputs from a user through an input device, accessible to the system through an I/O interface.

The computer system executes a set of instructions that are stored in one or more storage elements in order to process input data. The storage elements may also hold data or other information as desired. The storage element may be in the form of an information source or a physical memory element present in the processing machine.

The programmable or computer readable instructions may include various commands that instruct the processing machine to perform specific tasks such as the steps that constitute the method of the present invention. The method and systems described can also be implemented using only software programming or using only hardware or by a varying combination of the two techniques. The disclosed invention is independent of the programming language used and the operating system in the computers. The instructions for the invention can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The invention can also be implemented in all operating systems and platforms including, but not limited to, ‘Unix’, ‘DOS’, ‘Android’, ‘Symbian’, and ‘Linux’.

The programmable instructions can be stored and transmitted on a non-transitory computer readable medium. The programmable instructions can also be transmitted by data signals across a carrier wave. The disclosed invention can also be embodied in a computer program product comprising a computer readable medium, the product capable of implementing the above methods and systems, or the numerous possible variations thereof.

While various embodiments have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method performed by a computer for ranking social quality of content published on a plurality of web pages, the method comprising:
receiving at least one log record from a tracking component on at least one web page, the at least one log record indicative of at least one user activity on the at least one web page;
aggregating the at least one log record corresponding to the plurality of web pages based on one or more parameters;
assigning a first score for the plurality of web pages based on the aggregating, the first score being indicative of a social quality of content published in the at least one web page; and
ranking the plurality of web pages based on the first score.

2. The method of claim 1, wherein the at least one user activity comprises one or more of a sharing activity and a click-based activity on the plurality of web pages.

3. The method of claim 1, wherein the one or more parameters comprises at least one of total number of visits to at least one web page, total number of shares of at least one web page, total number of clicks of at least one web page, unique number of sharers for at least one web page, unique number of clickers for at least one web page, unique number of visitors at least one each web page, additional web page visits generated as a result of social clicks for at least one web page, category-relevant visits for at least one web page, category-relevant sharing activity for at least one web page, and category relevant click activity for at least one web page.

4. The method of claim 1 wherein the at least one log record comprises one or more of a cookie, a timestamp, an event type, a social destination, a content type identifier, a universal resource locator (URL), domain information and browser agent information.

5. The method of claim 1 further comprising categorizing the at least one log record in one or more predefined categories based on content of the at least one web page.

6. The method of claim 5 wherein the aggregating is based at least in part on the categorizing.

7. The method of claim 1 further comprising:
aggregating the at least one log record corresponding to a plurality of sub-domains associated with the plurality of web pages;
assigning a second score for the plurality of sub-domains based on the aggregating; and
ranking the plurality of sub-domains based on the respective second scores.

8. The method of claim 1 further comprising:
aggregating the at least one log record corresponding to a plurality of domains associated with the plurality of web pages;
assigning a third score for the plurality of domains based on the aggregating; and
ranking the plurality of domains based on the respective third scores.

9. A method performed by a computer for providing an advertising campaign on a plurality of domains, the method comprising:
receiving an advertising campaign description;
identifying at least one top ranking category from a plurality of categories associated with the advertising campaign description;
ranking the plurality of domains based on a social quality of the plurality of domains;
extracting a list of domains from the plurality of domains based on the at least one top ranking category and the ranking of the plurality of domains, wherein the list of domains corresponds to a preferred set of domains for providing the advertising campaign; and
publishing the advertising campaign on one or more web pages associated with at least one domain in the extracted list of domains.

10. The method of claim 9 wherein the advertising campaign description comprises at least one of keywords, a social pixel and at least one content category.

11. The method of claim 9 further comprising extracting information regarding at least one cookie from the extracted list of domains for providing the advertising campaign in a targeted manner, the at least one cookie representing a user visiting at least one web page associated with the at least one domain from the extracted list of domains.

12. The method of claim 11 further comprising recording and storing extracted information related to the at least one cookie.

13. The method of claim 9 wherein the ranking the plurality of domains comprises:
receiving at least one log record from a tracking component on at least one web page corresponding to the plurality of domains, the at least one log record indicative of at least one user activity on the at least one web page;
aggregating the at least one log record corresponding to the plurality of domains based on the one or more parameters;
assigning a score for the plurality of domains based on the aggregating; and
ranking the plurality of domains based on the score.

14. The method of claim 9 further comprising:
ranking a plurality of sub-domains associated with the plurality of domains;
extracting a list of sub-domains based at least in part on the ranking of the plurality of sub-domains; and
publishing the advertising campaign on a target web page based on the extracted list of domains and sub-domains, wherein the target web page is associated with at least one domain or sub-domain in the corresponding extracted list.

15. The method of claim 9 further comprising:
ranking a plurality of web pages associated with the plurality of domains;
extracting a list of web pages based at least in part on the ranking of the plurality of web pages; and
publishing the advertising campaign on a target web page based on the extracted list of domains and web pages, wherein the target web page is associated with at least one domain in the corresponding extracted list

16. A web analytic server for ranking social quality of content published in a plurality of web pages, the web analytics server comprising:
a tracking application module configured for receiving at least one log record from a tracking component on at least one web page, the at least one log record indicative of at least one user activity on the at least one web page;
an aggregating module configured for:
aggregating the at least one log record corresponding to the plurality of web pages based on one or more parameters;
assigning a first score to the plurality of web pages based on the aggregating, the first score indicative of social quality of the at least one web page; and
a ranking module configured for assigning a rank index to the plurality of web pages based on the assigned first score.

17. The web analytic server of claim 16 further comprising a categorization module configured for categorizing the at least one log record based on content of the web page associated with the at least one log record.

18. The web analytic server of claim 17 further comprising an advertising campaign module configured for receiving an advertising campaign description.

19. The web analytic server of claim 18, wherein the categorization module identifies at least one top ranking category associated with the advertising campaign description, the at least one top ranking category being identified from a plurality of categories associated with a plurality of domains, each domain being associated with one or more of the plurality of web pages.

20. The web analytic server of claim 19 further comprising an extraction module configured for extracting at least one of a list of domains, a list of sub-domains, and a list of web pages based on the at least one identified top ranking category and rank assigned to the plurality of web pages, the plurality of sub-domains, and the plurality of domains, the list corresponding to a relative preference for providing an advertising campaign on one or more domains, one or more sub-domains, and one or more web pages.

21. A method performed by a computer for ranking a social quality of an entity associated with a plurality of web pages, the method comprising:
receiving log records from a tracking component on the plurality of web pages, the log records indicative of at least one user activity on the plurality of web pages;
aggregating the log records corresponding to the entity;
assigning a score to the entity for the plurality of web pages based on the aggregating, the score being indicative of a social quality of content associated with the entity; and
ranking the entities based on the respective scores.

22. A method as claimed in claim 21, wherein the entity corresponds to a domain or a sub-domain associated with the plurality of web pages.

23. A method as claimed in claim 22, wherein the assigning comprises:
assigning a first score to the plurality of web pages,
assigning a second score to a sub-domain associated with the plurality of web pages; and
assigning a third score to a domain associated with the plurality of web pages.

24. A method as claimed in claim 23, wherein the ranking comprises:
aggregating two or more of the first score, the second score, or the third score to generate a combined score; and
ranking the corresponding entity based at least in part on the combined score.

25. A computer program product for use with a computer, the computer program product comprising a non-transitory computer usable medium having a computer readable program code embodied therein for ranking social quality of content published on a plurality of web pages, the computer program product code comprising:
program instructions for receiving at least one log record from a tracking component on at least one web page, the at least one log record indicative of at least one user activity on the at least one web page;
program instructions for aggregating the at least one log record corresponding to the plurality of web pages based on one or more parameters;
program instructions for assigning a first score for the plurality of web pages based on the aggregating, the first score being indicative of a social quality of content published in the at least one web page; and
program instructions for ranking the plurality of web pages based on the first score.
